(19) United States
(12) Patent Application Publication
(10) Pub. No.: US 2023/0356622 A1
(43) Pub. Date: Nov. 9, 2023

(54) METHOD AND SYSTEM FOR CONTROLLING POWER OF VEHICLE

(71) Applicants: HYUNDAI MOTOR COMPANY, Seoul (KR); KIA CORPORATION, Seoul (KR)

(72) Inventor: Taek Hyun Jung, Seoul (KR)

(21) Appl. No.: 17/972,089

(22) Filed: Oct. 24, 2022

(30) Foreign Application Priority Data
May 4, 2022 (KR) 10-2022-0055311

(51) Int. Cl. B60L 55/00

(52) U.S. Cl. CPC B60L 55/00

(57) ABSTRACT

A method for controlling power of a vehicle includes identifying the current location of a vehicle, determining whether to enter the a grid code-changing region based on the identified current location of the vehicle, and controlling the power supplied from the vehicle to the power grid according to a parameter corresponding to the grid code of the region when entering to the grid code-changing region is determined.

### CROSS REFERENCE TO RELATED APPLICATIONS

The present application claims priority to Korean Patent Application No. 10-2022-0055311, filed May 4, 2022, the entire contents of which is incorporated herein for all purposes by this reference.

### TECHNICAL FIELD

The present disclosure relates to a method and a system for controlling power of a vehicle, which can satisfy a grid code changed by power supplied to a power grid from a vehicle when the grid code required from a power system operator of each region is changed as a vehicle moves, thereby preventing the operation of a vehicle to grid (V2G) function from being restricted.

### BACKGROUND

As the distribution of vehicles using power as a power source is expanding, the power demand increased rapidly, and the development of technology to solve the problem is required.

In addition, as the means to satisfy the demand for power, attempts to utilize renewable energy such as wind power and solar power are increasing due to the trend of environment-friendly energy to minimize environmental pollution. However, the supply is unstable for renewable energy, so an energy storage device capable of balancing supply and demand is required.

The battery of an electrified vehicle having an electric motor as a drive source may serve as the energy storage device, and to allow the electrified vehicle to perform such a function, the vehicle to grid (V2G) technology has to be implemented to supply the power stored in the vehicle battery to the power grid. Unlike the conventional onboard charger (OBC), the V2G is a concept that allows rechargeable environment-friendly vehicles such as electric vehicles to be connected to the power grid through a bidirectional OBC that receives power from the power grid but also supplies power to the power grid. In this case, the vehicle may function as a type of energy storage system (ESS).

When the V2G technology is implemented, the power distribution operator requires a grid code, an electrical/functional specification for linking the power with the power system to prevent the power grid from being adversely affected by the quality of vehicle power supplied by V2G technology. The vehicle must comply with the grid code to operate the V2G technology.

The grid code is operated with different specifications depending on countries or states. As the conventional power generation devices are operated in stationary places, there was no need to respond to changes in the grid code. However, due to the characteristics of the vehicles, which are capable of moving between regions, when the setting is fixed according to one of the grid codes, there may be several restrictions in operating the V2G technology when moving between regions.

In addition, there may be a problem in that raw cost and production efficiency may be deteriorated as the specifications for response are diversified by sales region to provide V2G technology.

Accordingly, there is a need to develop a technology capable of responding to changes in grid codes due to regional changes.

### SUMMARY

Therefore, the present disclosure has been made in view of the above problems, and it is an object of the present disclosure to provide a method and a system for controlling power of a vehicle that identifies the current location of the vehicle, confirms whether the vehicle enters the region requiring different grid codes based on the identified current location, and controls the power supplied to the power grid in response to changes in grid code changes to solve V2G technology operation limitations due to movement of the vehicle.

To accomplish the above object, according to one aspect of the present disclosure, there is provided a method for controlling power of a vehicle comprising the steps of identifying the current location of a vehicle, determining whether to enter a grid code-changing region based on the identified current location of the vehicle, and controlling the power supplied from the vehicle to the power grid according to parameters corresponding to the grid code of the region when entering to the grid code-changing region is determined.

The step of determining whether enter to the grid code-changing region may comprise a step of confirming whether a regional code of the region where the vehicle was previously located matches the regional code of the region where the vehicle is currently located among the regional codes assigned to each regions having the identical grid code, and as a result of the confirmation if the regional codes do not match, it may be determined that the grid code has entered the changing region.

The step of controlling the power supplied to the power grid in the vehicle may include a step of extracting parameters that match with the regional code of the region where the vehicle is currently located from the grid code map in which the regional code and parameters corresponding to the grid code of the regions are matched.

The parameters may include at least one of a normal voltage range, a normal frequency range, a reactive power control according to system voltage variations, an active power control according to system voltage variations, an active power control according to system frequency variations, an output variation rate control, a voltage that determines the maintenance of power system connection, a voltage that determines power system separation, a frequency that determines maintenance of power system connection, and a frequency that determines power system separation.

The step of controlling power supplied to the power grid from the vehicle comprises controlling the power supplied from the vehicle to the power grid according to a power control logic in which the parameters correspond to the grid code of the region where the vehicle is currently located.

The method for controlling power of the vehicle according to the present disclosure may further comprise a step of outputting information on change of power control after the step of controlling the power supplied from the vehicle to the power grid.

The step of identifying the current location of the vehicle may identify the current location of the vehicle based on a GPS signal received from the satellite.

To accomplish the above object, according to one aspect of the present disclosure, there is provided a system for controlling power of a vehicle comprising a location identification unit identifying the current location of a vehicle and determining whether to enter the grid code-changing region based on the identified current location of the vehicle, and a power control unit controlling the power supplied from the vehicle to the power grid according to parameters corresponding to the current location of the vehicle.

The location identification unit may request a variation response to the power control unit when determined that the vehicle is entered into a grid code-changing region.

The location identification unit may store a regional code map, including the regional code assigned to each region with identical grid codes. A request to respond to the grid code change may include the regional code according to the region where the vehicle is currently located.

The power control unit stores a grid code map in which the regional code and the parameters corresponding to the grid code of the corresponding region are matched, and based on the stored grid code map and the regional code provided by the location identification unit, and the parameters may be extracted corresponding to the grid code of the corresponding region.

The power control unit may control power supplied from the vehicle to the power grid according to power control logic to which parameters corresponding to the changed grid code are applied.

The location identification unit may include an audio/video/navigation/telematics (AVNT) device of the vehicle, and the power control unit may include an onboard charger (OBC) of the vehicle.

The power control system of the vehicle, according to the present disclosure, may further include an interface unit, and the power control unit may output a change completion signal when changing power control is completed, and the interface unit may output information on the change of power control when the change completion signal is outputted.

The interface unit may include the AVNT device of the vehicle.

The location identification unit may receive a GPS signal from the satellite and identify the current location of the vehicle via the received GPS signal.

According to a method and a system for controlling power of a vehicle of the present disclosure, by allowing to respond to the grid code changes required by the power system operator in each region, and preventing V2G functions from being restricted due to vehicle movement, the V2G functions that are ensured to be compatible with the system freely regardless of regional movement can be used. In addition, when producing vehicles equipped with V2G functions, can improve cost and production efficiency by eliminating the need to diversify vehicle specifications to respond to the grid code of each sales region.

It will be appreciated by persons skilled in the art that the effects that can be achieved with the present disclosure are not limited to what has been particularly described herein above and other advantages of the present disclosure will be more clearly understood from the following detailed description taken in conjunction with the accompanying drawings.

### BRIEF DESCRIPTION OF THE FIGURES

FIG. 1 is a configuration diagram showing a power control system of a vehicle according to an embodiment of the present disclosure.

FIG. 2 is a configuration diagram showing a location identification unit from a power control system of a vehicle according to an embodiment of the present disclosure.

FIG. 3 is a configuration diagram showing a power control unit from a power system of a vehicle according to an embodiment of the present disclosure.

FIG. 4 is a flowchart showing a method for controlling power of a vehicle according to an embodiment of the present disclosure.

FIG. 5 is a view showing an example of a reference of a reactive power control according to a system voltage variation among parameters corresponding to a grid code in a method for controlling power of a vehicle according to an embodiment of the present disclosure.

### DETAILED DESCRIPTION

Regarding embodiments of the present disclosure disclosed in this specification or application, the specific structural or functional description is merely illustrative for the purpose of describing the embodiments of the disclosure, and embodiments of the disclosure may be implemented in various forms but not be construed as being limited to the embodiments set forth in this specification or application.

Because the embodiments of the disclosure may be variously modified and have various forms, specific embodiments will be illustrated in the drawings and described in detail in this specification or application. However, it should be understood that embodiments of the disclosure are intended not to be limited to the specific embodiments but to cover all modifications, equivalents or alternatives without departing from the spirit and technical scope of the present disclosure.

Unless defined otherwise, all technical and scientific terms used herein have the same meaning as commonly understood by one of ordinary skill in the art to which this inventive concept belongs. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, embodiments of the present disclosure will be described in greater detail with reference to the accompanying drawings. Like numerals refer to like elements throughout.

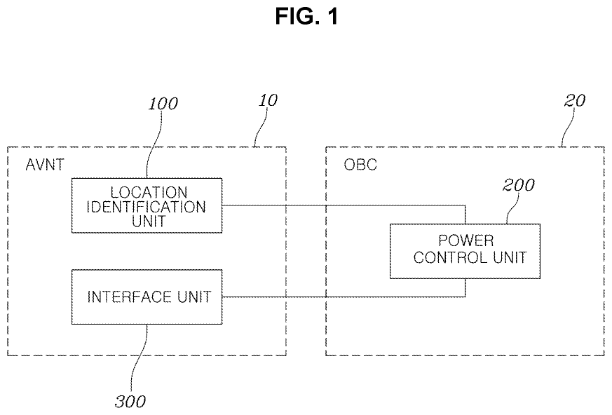

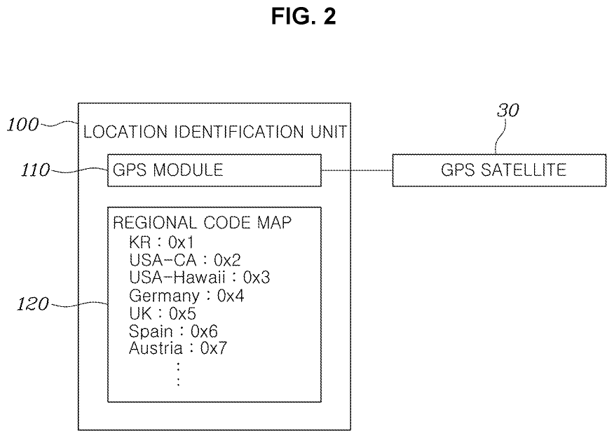

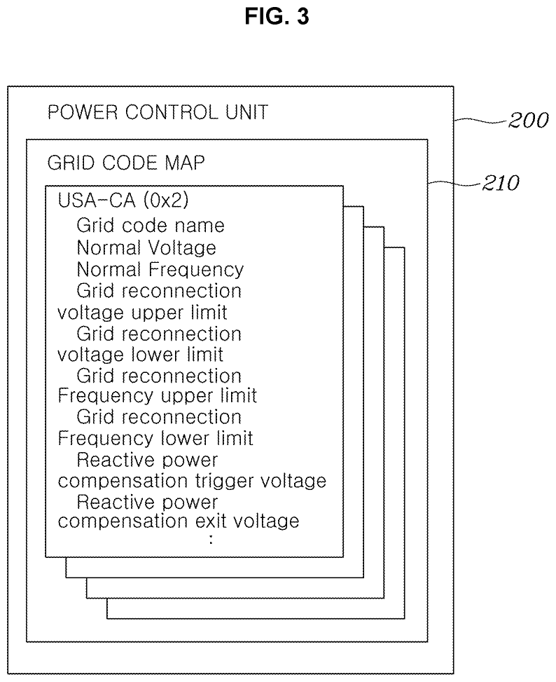

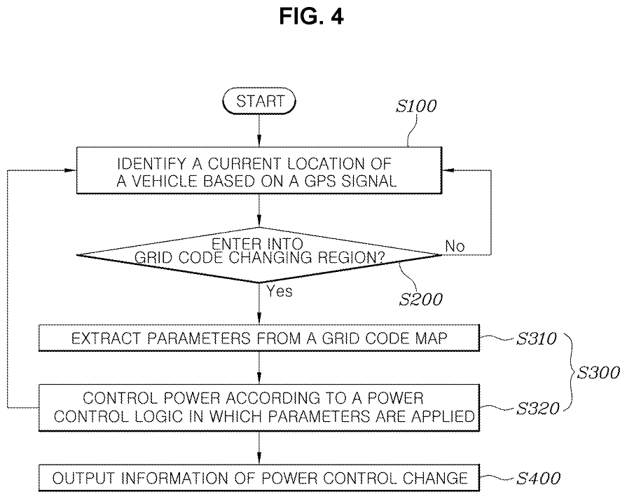

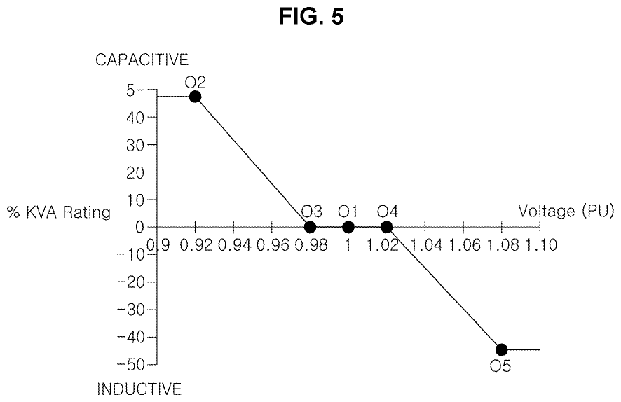

FIG. 1 is a configuration diagram showing a power control system of a vehicle according to an embodiment of the present disclosure, FIG. 2 is a configuration diagram showing a location identification unit from a power control system of a vehicle according to an embodiment of the present disclosure, FIG. 3 is a configuration diagram showing a power control unit from a power system of a vehicle according to an embodiment of the present disclosure, FIG. 4 is a flowchart showing a method for controlling power of a vehicle according to an embodiment of the present disclosure, and FIG. 5 is a view showing an example of a reference of a reactive power control according to a system voltage variation among parameters corresponding to a grid code in a method for controlling power of a vehicle according to an embodiment of the present disclosure.

Prior to describing a method for controlling power of a vehicle according to embodiments of the present disclosure, a power control system of a vehicle applicable to the embodiments will be described first with reference to FIG. 1.

FIG. 1 is a configuration diagram showing a power control system of a vehicle according to an embodiment of the present disclosure, and referring to FIG. 1, the power control system of a vehicle according to an embodiment of the present disclosure may include a location identification unit 100, a power control unit 200, and an interface unit 300.

The location identification unit 100, the power control unit 200, and the interface unit 300 may include in the vehicle, the vehicle provided with each component that receives power from the power grid is stored in a battery, and it is preferable to be an electrified vehicle capable of generating drive force by supplying power from a stored battery to a motor. For example, an electric vehicle (EV) or a plug-in hybrid electric vehicle (PHEV) is suitable for such an electrified vehicle. Moreover, it is suitable that a bidirectional OBC 20 is provided to receive power from the power grid and supply the power stored in the vehicle to the power grid. FIG. 1 mainly shows components related to embodiments of the present disclosure. Of course, the actual system implementation may include more or fewer components such as power factor correction (PFC), inverter (INV), and battery. Hereinafter, each component will be described.

The location identification unit 100 continuously identifies the current location of the vehicle when the vehicle is started and starts to drive and determines whether the vehicle has entered the grid code-changing region based on the current location of the identified vehicle.

Conventional power generation apparatuses are operated in a stationary state in one site, and once the power control-related settings are performed according to the grid code required by the operator of the power system in the region where the site is located, there is no change to change the settings, however with the implementation of the V2G function, as the vehicle acts a sort of an ESS role, there is no need to change the grid code-related settings. As the location identification unit 100 determines whether to enter the grid code-changing region based on the identified current location, it is possible to continuously monitor whether it is necessary to respond to grid code changes.

In addition, the location identification unit 100 may transmit a request to change response to the power control unit 200 when the vehicle enters the grid code-changing region, and the power control unit 200 receiving the request to change response may control power according to the request to response.

In this case, the location identification unit 100 may store a regional code map 120, including the regional code assigned to each region with identical grid codes. Among the regional codes of the regional code map 120, the regional code of the region where the vehicle is currently located may be transmitted by including in the request to change response. Detailed descriptions of the regional code map 120 are discussed below with reference to FIG. 2.

The power control unit 200 controls the power supplied from the power grid from the vehicle according to the parameters corresponding to the grid code of the region where the vehicle is currently located.

The power control unit 200 may store a grid code map 210 in which the regional code and the parameters corresponding to the grid code of the corresponding region are matched, and based on the stored grid code map 210 and the regional code provided from the location identification unit 100, the parameters may be extracted corresponding to the grid code of the corresponding region. Thereafter, by controlling power by reflecting the extracted parameters, the grid code of the corresponding region may be satisfied. Detailed descriptions of the grid code map 210 are discussed below with reference to FIG. 3.

In this case, the power control unit 200 may set the power control logic by applying the parameters corresponding to the changed grid code, and according to the power control logic, the power supplied from the vehicle to the power grid can be controlled so that the power supplied from the vehicle can satisfy the grid code.

In addition, the power control system of the vehicle according to the present disclosure may further include an interface unit 300, and in the case of the power control system of the vehicle includes the interface unit 300, and the power control unit 200 may receive a change completion signal indicating that the change of power control is completed and output the information on change of power control to provide information on the change of power control to a user.

Meanwhile, in the power control system of the vehicle according to the present disclosure, the location identification unit 100 and the interface unit 300 may be included in the Audio/Video/Navigation/Telematics (AVNT) device 10, and the power control unit 200 may be included in the OBC 20. The production or assembly processes of additional components to operate the V2G function while the vehicle moves may be omitted, as the system can be implemented through the configuration previously provided in the vehicle.

FIG. 2 is a configuration diagram showing a location identification unit from a power control system of a vehicle according to an embodiment of the present disclosure. Referring to FIG. 2, the location identification unit 100 may receive a GPS (global positioning system) signal from a GPS satellite 30 through a GPS module 110 and include the regional code map 120.

As the location identification unit 100 receives the GPS signal from the satellite, the current location of the vehicle can be identified via the GPS signal. When the state or country in which the vehicle is located changes according to the movement of the vehicle, the user may directly input that the vehicle has moved. However, by using the GPS signal, the current location of the vehicle can be automatically and continuously updated, therefore determining whether to enter the grid code-changing region also be automatically performed by reflecting the updated current location of the vehicle. In addition, as the current location of the vehicle is identified using the GPS signal, the accuracy of identifying the location also is improved.

The regional code map 120 may include the regional code assigned to each region having the identical grid code. The grid code required is changed when a vehicle enters another region, including when moving the vehicle within the European continent, such as moving from Germany to France, moving between states in the United States, moving from California to Arizona or moving between frequency-changing locations. By grouping regions with the same grid code into one region and assigning each region code, it is possible to determine whether the vehicle has entered the grid code-changing region by comparing the regional code of the previously located region with the regional code of the currently located region.

FIG. 3 is a configuration diagram showing a power control unit in a power control system of a vehicle according to an embodiment of the present disclosure, and referring to FIG. 3, the power control system of a vehicle according to an embodiment of the present disclosure may include the grid code map 210.

The grid code map 210 may be stored by matching the regional code and the parameters corresponding to the grid code of the corresponding region. As the regional code and the parameters corresponding to the grid code of the region are matched in the grid code map 210, the regional code may be input to extract the parameters corresponding to the grid code of the region without having to be separately input. By applying the above, it is possible to satisfy the grid code required by the operator of the power system in the region by controlling the power supplied from the vehicle to the power grid. For example, as indicated in FIG. 3, in the grid code 210, regions (USA-CA), regional code (0X2), and the parameters, such as normal voltage, normal frequency, and the like, correspond to the grid code of the corresponding region are matched, and such matching may be stored in lists for each of the grid code or the regional code.

The parameters stored in the grid code 210 may include at least one of: a normal voltage range standard, a normal frequency range standard, a reactive power control standard according to system voltage variations, an active power control standard according to system voltage variations, an active power control standard according to system frequency variations, an output variation rate control standard, a voltage standard that determines the maintenance of power system connection, a voltage standard that determines power system disconnection, a frequency standard that determines maintenance of power system connection, and a frequency standard that determines power system disconnection.

When controlling the power supplied to the power grid from the vehicle according to the parameters corresponding to the grid code of the corresponding region by entering the grid code-changing region, the power is controlled according to parameters including all items defined in the grid code of the region. As the required parameters are stored according to the grid code, the power can be controlled immediately according to the stored parameters by omitting the step of confirming the parameters or inputting the parameters separately through communication with the outside.

In addition, when controlling the power supplied from the vehicle to the power grid according to parameters corresponding to the changed grid code, the settings of all items required by the grid code in the region may be changed simultaneously without an order of priority.

FIG. 4 is a flowchart showing a method for controlling power of a vehicle according to an embodiment of the present disclosure, and referring to FIG. 4, the method for controlling power of the vehicle comprises the steps of identifying the current location of a vehicle at S100, determining whether to enter a grid code-changing regions based on the identified current location of the vehicle at S200, controlling power supplied from the vehicle to the power grid according to parameters corresponding to the grid code of the region when entering to the grid code-changing region is determined at S300), and outputting information on information on change of power control at S400. FIG. 4 is a view showing embodiments of the present disclosure, and in terms of related steps, it will be understood that an implementation of an actual method for controlling power method may include additional steps or fewer steps than shown. Hereinafter, each step will be described.

The step S100 of identifying the current location of the vehicle is performed to confirm the need to respond to grid code changes based on the current location of the vehicle, and may be performed by the location identification unit 100.

In the step S100 of identifying the current location of the vehicle, the identification of the current location may be performed in a manner such as a user directly inputting the current location, but may also be performed based on the GPS signal received from the GPS satellite 30, which identifies the current location of the vehicle based on the GPS signal, allowing to automatically update the current location of the vehicle without having to intervene separately. In addition, the accuracy of identifying the location also be improved, thereby preventing an erroneous operation of the power control due to incorrect location identification.

The step S200 of determining whether to enter the grid code-changing region may determine whether to enter the grid code-changing region based on the current location of the identified vehicle, and may be performed in the location identification unit 100.

The step S200 of determining whether to enter the grid code-changing region may comprise the step of: confirming whether a regional code of the region where the vehicle was previously located matches the regional code of the region where the vehicle is currently located among the regional codes assigned to each regions having the identical grid code, and when the regional codes do not match from a result of the confirmation, it may be determined that the vehicle has entered the grid code-changing region.

The regional code may be assigned to each region having the identical grid code and stored in the location identification unit 100, the location identification unit does not need to confirm the parameters required by the grid code one by one to determine whether the regional code has been previously assigned matches, thereby simply determining whether the grid code has entered the region.

In the step S300 of controlling the power supplied from the vehicle to the power grid, when it is determined that the vehicle has entered to the grid code-changing region, the power supplied from the vehicle to the power grid is controlled according to the parameters corresponding to the grid code of the corresponding region, and may be performed by the power control unit 200.

The step S300 of controlling the power supplied to the power grid in the vehicle may include the step S310 of extracting a parameter that matches with the regional code of the region where the vehicle is currently located from the grid code map 210 in which the regional code and parameters corresponding to the grid code of the regions are matched. The regional code may be provided from the location identification unit 100, and the grid code map 210 may be stored in the power control unit 200.

By substituting the regional code provided from the location identification unit 100 into the grid code map 210 stored in the power control unit 200, the parameters according to the grid code matched with the regional code may be extracted from the grid code 210. Accordingly, the required parameters according to the grid code of the corresponding region can be secured without the step of having to input separately of the user or the step of the communication with outside.

In addition, the step S300 of controlling the power supplied to the power grid from the vehicle may further include the step S310 of controlling the power supplied from the vehicle to the power grid according to a power control logic in which the parameters correspond to the grid code of the region where the vehicle is currently located. The above process may be performed in the power control unit 200 and may be performed through a configuration of a processor that may be provided in the power supply unit 200. By using the power control logic, parameters corresponding to the grid code of the region where the vehicle is currently located are applied to a preconfigured logic to quickly change the power control of the vehicle, so that the V2G function can be operated without a gap even after entering the grid code-changing region.

FIG. 5 is a view showing an example of a reference of a reactive power control according to a system voltage variation among parameters corresponding to a grid code in a method for controlling power of a vehicle according to an embodiment of the present disclosure and referring to FIG. 5, the parameters corresponding to the grid code of the corresponding regions may include a reactive power control standards according to the system voltage variation.

To describe in detail with reference to an example of FIG. 5, it is configured such that a unity power factor operation is performed in the case of point O1 where a voltage value is 1 and a reactive power value is 0%, a reactive power feed is performed in the case of point O2 where the voltage value is 0.92 and the reactive power value is 48.4%, the unity power factor is performed in the case of point O3 where the voltage value is 0.98 and the reactive power value is 0%, the unity power factor is performed in the case of point O4 where the voltage value is 1.02 and the reactive power value is 0%, and the absorption of reactive power is performed in the case of point O5 where the voltage value is 1.08 and the reactive power value is 48.4%. Such configurations may be changed to correspond to the grid code of each region whenever entering the grid code-changing area.

By controlling power as in the example above, the vehicle may use the V2G function by satisfying the grid code of the corresponding region and by changing the power control setting. Despite the movement of the vehicle, there is no restriction from using the V2G function.

The method for controlling power of the vehicle according to the present disclosure may further comprise the step S400 of outputting information of power control change after the step S300 of controlling the power supplied from the vehicle to the power grid. Outputting the information of power control change may be performed in the interface unit 300. The power control unit 200 transmits a change completion signal when the power control change is completed according to the parameters corresponding to the grid code of the region where the vehicle is current is currently located, the interface unit 300 receiving the signal provides the information of power control change through a display or audio so that the user may recognize the power control changes by auditory or visually. Accordingly, the user may confirm whether the power control has been changed and whether the V2G function operates normally even after regional changes.

According to a method and a system for controlling power of a vehicle of the present disclosure, by allowing to respond to the grid code changes required by the power system operator in each region, and preventing V2G functions from being restricted due to vehicle movement, the V2G functions that are ensured to be compatible with the system freely regardless of regional movement can be used. In addition, when producing vehicles equipped with V2G functions, can improve cost and production efficiency by eliminating the need to diversify vehicle specifications to respond to the grid code of each sales region.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A method for controlling power of a vehicle comprising:
identifying a current location of a vehicle;
determining whether to enter a grid code-changing region based on the identified current location of the vehicle; and
controlling power supplied from the vehicle to a power grid according to parameters corresponding to a grid code of a region when entering to the grid code-changing region is determined.

2. The method of claim 1, wherein determining whether to enter the grid code-changing region comprises:
confirming whether a regional code of a region where the vehicle was previously located matches the regional code of the region where the vehicle is currently located among the regional codes assigned to each regions having the identical grid code; and
determining that the vehicle has entered the grid code-changing region, when the regional codes do not match a result of a confirmation.

3. The method of claim 2, wherein controlling power supplied from the vehicle to the power grid comprises:
extracting parameters that match the regional code of the region, where the vehicle is currently located from a grid code map in which the regional code and parameters corresponding to the grid code of the regions are matched.

4. The method of claim 1, wherein the parameters include at least one of: a normal voltage range, a normal frequency range, a reactive power control according to system voltage variations, an active power control according to system voltage variations, an active power control according to system frequency variations, an output variation rate control, a voltage that determines the maintenance of power system connection, a voltage that determines power system disconnection, a frequency that determines maintenance of power system connection, and a frequency that determines power system disconnection.

5. The method of claim 1, wherein controlling power supplied from the vehicle to the power grid comprises controlling the power supplied from the vehicle to the power grid according to a power control logic in which the parameters correspond to the grid code of the region where the vehicle is currently located.

6. The method of claim 1, further comprising outputting information of power control change after controlling the power supplied from the vehicle to the power grid.

7. The method of claim 1, wherein identifying the current location of the vehicle identifies the current location of the vehicle based on a GPS signal received from a satellite.

8. A system for controlling power of a vehicle comprising:
a location identification unit configured to identify a current location of a vehicle, and to determine whether to enter a grid code-changing region based on an identified current location of the vehicle; and
a power control unit configured to control the power supplied from the vehicle to the power grid according to parameters corresponding to the current location of the vehicle.

9. The system of claim 8, wherein the location identification unit is configured to request a variation response to the power control unit when it is determined that the vehicle is entered into a grid code-changing region.

10. The system of claim 9, wherein the location identification unit is configured to store a regional code map, including a regional code assigned to each region with identical grid codes, and a request to respond to grid code changes includes the regional code according to the region where the vehicle is currently located.

11. The system of claim 10, wherein the power control unit is configured to store a grid code map in which the regional code and parameters corresponding to the grid code of the corresponding region are matched, and based on the regional code provided from the location identification unit, the parameters are extracted corresponding to the grid code of the corresponding region.

12. The system of claim 8, wherein the power control unit is configured to control the power supplied from the vehicle to the power grid according to a power control logic in which the parameters correspond to the grid code of the region where the vehicle is currently located.

13. The system of claim 8, wherein the location identification unit includes an Audio/Video/Navigation/Telematics (AVNT) device in the vehicle, and the power control unit includes an onboard charger (OBC) of the vehicle.

14. The system of claim 8, further comprising:
an interface unit, wherein the power control unit outputs a change completion signal when changing power control is completed, and the interface unit outputs information on the change of power control when the change completion signal is outputted.

15. The system of claim 14, wherein the interface unit includes the AVNT device of the vehicle.

16. The system of claim 8, wherein the location identification unit receives a GPS signal from a satellite and identifies the current location of the vehicle via the GPS signal.
